(19) United States
(12) Patent Application Publication
(10) Pub. No.: US 2020/0190768 A1
(43) Pub. Date: Jun. 18, 2020

(54) SCREENING BUCKET

(71) Applicant: CANGINI BENNE S.R.L., Sarsina (FC) (IT)

(72) Inventor: Davide CANGINI, Mercato Saraceno (FC) (IT)

(21) Appl. No.: 16/349,326

(22) PCT Filed: Dec. 29, 2017
(86) PCT No.: PCT/IB2017/058513

§ 371 Date: May 13, 2019

(30) Foreign Application Priority Data
Dec. 29, 2016 (IT) 102016000132388

(51) Int. Cl. E02F 7/06; B07B 1/22

(52) U.S. Cl. CPC E02F 7/06; E02F 3/407; B07B 1/22

(57) ABSTRACT

Screening bucket (1) provided with a box-type frame (10) having at least a first space (20) suitable to house a first screening basket (28) rotatable around a first pivot axis (40)(40′); frame (10) having a mouth portion (12)(12′) and a longitudinal closing member (11) (11′) for each space (20)(20′); each first bucket (28)(28′) being closed at the back; frame (10) comprises at least one second space (20′) adjacent to first space (20) and suitable to house a second screening basket (28′) rotatable around a second pivot axis (40′) parallel to first pivot axis (40).

The present invention relates to a screening bucket. In particular, the present invention relates to a screening bucket that can be actuated by means of an articulated arm of an earthwork machine. In more detail, the present invention relates to a screening bucket that can be actuated by means of an articulated arm of an earthwork machine in order to separate elements of different sizes from heterogeneous excavated material.

### BACKGROUND TO THE INVENTION

As known, screening buckets are excavating equipment that, coupled to the end of an excavating arm of a self-propelled heavy vehicle or machine (here below also called earthwork machine), allow to take heterogeneous material and to select it, separating the fine fractions from the rough fractions, and keeping these latter inside a basket provided with fixed or rotating grids. In case of rotating grids, the screening of the material is performed by means of a rotating cylindrical basket, usually driven into rotation by means of a hydraulic rotary actuator carried by the bucket frame at opposite side from the bucket blade, wherein the blade is usually provided with teeth for crushing the surface of the area to be excavated. Moreover, the bucket has, in front of the respective basket, a mouth portion for conveying the excavated material into the basket in an easier way. In case of screening buckets applied to shovels, the width of these tools is usually equal to the gauge of the heavy machine. This facilitates taking the excavated material, with a lower number of manoeuvres for the operator.

It is clearly apparent that the pore size of the material kept in the basket depends on the dimension of the openings provided in the mantle of the rotating basket; It is also clearly apparent that the volume of the basket shall be adapted to the volume of excavated material that shall be screened; the greater the volume to be treated at each stroke of the bucket, the greater the basket volume. In this case, to limit the dimension of the basket overhang, so as to limit the distance of the respective free end from the pivot axes of the corresponding bucket, it is necessary that the diameter of the basket is adequately sized, taking into account the mechanical features of the bucket supporting it and the articulated arms supporting the bucket, as well as the hydraulic power supplied through the self-propelled machine supporting all what mentioned above, acting as a frame. This allows to provide machines where the torque to be transmitted to the bucket to keep it in balance will be satisfying in every operative condition, the vibrations of the system bucket-articulated arms will be under control, and the machine will always be able to operate in safety conditions from a dynamic point of view.

On the other hand, it is clearly apparent that the greater the diameter of a bucket basket, the more difficult and dangerous manoeuvring the machine carrying the bucket, as the free view of the work volume where the operator shall operate is strongly limited. Moreover, an increase in the sizes of the gauge of the heavy machine supporting the bucket will result in an increase in the bucket dimension, thus making more difficult conveying the excavated material inside the basket. This forces to increase proportionally the dimension of the mouth portion, both transversally and longitudinally. Therefore, the bucket will be more bulky and therefore more difficult to be manoeuvred in the work space. For example, an operator can actuate a self-propelled heavy machine in safety condition only if the line of vision is at least equal to that set forth in the industry standards.

If this does not occur, the risk increases of not seeing, and therefore of impacting against, structures or people that are near the heavy machine and, in most serious cases, to mow down operators working around the machine with the bucket or the articulated support arms. To avoid these accidents and to keep the safety level of a heavy machine provided with a screening bucket as described above within the levels set forth in the laws, it is necessary that the dimensions of the heavy machine are adequate to those of the screening baskets installed on it. In particular, these machines shall have a cab in sufficiently raised position, and be therefore provided with wheels of large diameter and, therefore, with very long arms, therefore with hydraulic units of adequate power and therefore provided with adequate motors. Definitely, self-propelled heavy machines that can be equipped with screening buckets with baskets of large dimensions, and corresponding adequate mouth portions, are significantly bulky and, consequently, very expensive.

In view of the situation described above, to allow companies of any dimension operating in the excavation field to have efficient screening buckets, it should be desirable to define the inventive concept of a screening bucket allowing to treat significant volumes of excavation material keeping the vertical and longitudinal dimension of the screening bucket within ordinary values. In this way the bucket would have the same operativeness, with the advantage of overcoming the prior art drawbacks and allowing, at the same time, to upgrade the park of the self-propelled heavy machines of ordinary dimensions for screening excavated material. A bucket of this type would define a new standard for screening excavated material taken with a stroke of a bucket done with self-propelled heavy machines of ordinary dimensions and capabilities.

### SUMMARY OF THE PRESENT INVENTION

The present invention relates to a screening bucket. In particular, the present invention relates to a screening bucket that can be actuated by means of an articulated arm of an earthwork machine. In more detail, the present invention relates to a screening bucket that can be actuated by means of an articulated arm of an earthwork machine in order to separate elements of different sizes from excavated material.

The object of the present invention is to provide a screening bucket that allows to screen significant masses of heterogeneous material, so as to separate from it fractions of given size, leaving a line of vision that is at least equal to that provided for in the reference standards and laws.

According to the present invention a screening bucket is provided, whose main features will be described in at least one of the appended claims.

### BRIEF DESCRIPTION OF DRAWINGS

Further characteristics and advantages of the screening bucket will be more apparent from the description below, set forth with reference to the attached drawings that illustrate some examples of embodiment, where identical or corresponding parts of the devices mentioned above are identified by the same reference numbers. In particular:

FIG. 1 is a schematic perspective view of a first embodiment of a screening bucker according to the present invention;

FIG. 2 is a schematic side perspective view of FIG. 1, partially cut-away and with some parts removed for the sake of clarity;

FIG. 3 is a perspective front view of FIG. 1, with some parts removed for the sake of clarity;

FIG. 4 is a front view of FIG. 3, with some parts removed for the sake of clarity;

FIG. 5 is a diagram of a variant of FIG. 1;

FIG. 6 is a perspective front view of a variant of FIG. 1, with some parts removed for the sake of clarity; and

FIG. 7 is a diagram of a variant of FIG. 6.

### DETAILED DESCRIPTION OF THE PRESENT INVENTION

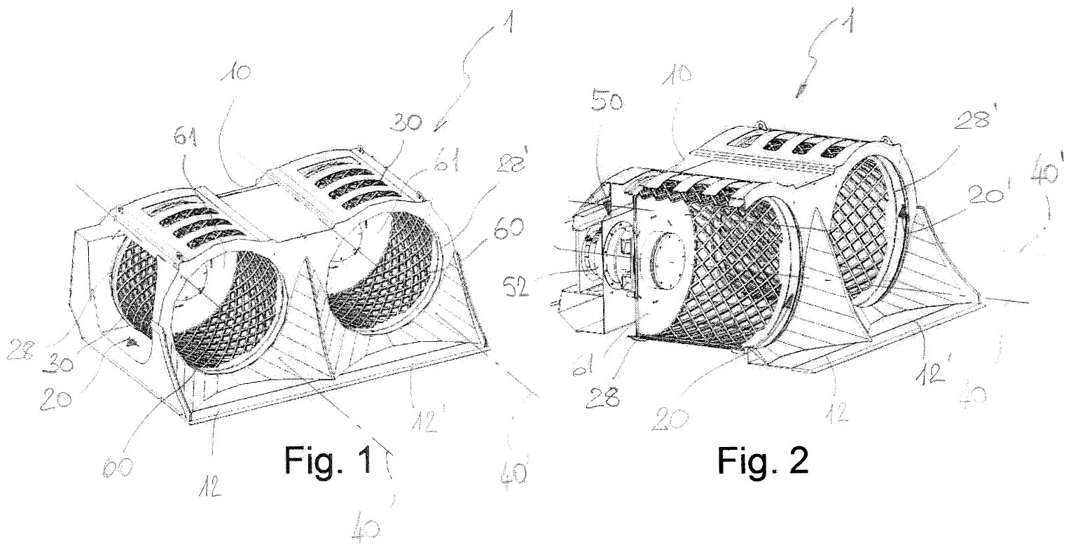

In FIG. 1, number 1 indicates, as a whole, a screening bucket provided with a box-shaped frame 10 having a first space 20 and a second space 20′ that are cylindrical and closed at the back by means of a bottom 11 and a bottom 11′ respectively, both coupled to the frame 10 in a selectively releasable way. Each space 20/20′ is suitable to house respectively a first screening basket 28 and a second screening basket 28′. Both baskets 28 and 28′ are carried by the frame 10 in a rotating manner around respective first pivot axis 40 and second pivot axis 40′. The first basket 28 and the second basket 28′ have a plurality of first holes 34 of given width and shape.

As shown in FIG. 1, the first basket 28 and the second basket 28′ are substantially identical. The baskets are shaped like a prism, in particular they are cylindrical, but they can also have a different shape however without departing from the protective scope of the invention. Respective known actuation devices 50 are associated to the first and to the second baskets 28/28′, wherein only one of these devices is schematically illustrated in FIG. 2. Each actuator 50 is carried by the frame 10 at the back so as to rotate the first and the second baskets 30 and 30′ and therefore to allow, in use, the screening through rotation by means of the whole bucket As shown in FIGS. 1 and 2, the frame 10 supports, for each basket 28/28′, and therefore for each said space 20, a mouth portion 12/12′, whose function is to convey the excavated material inside the respective basket 28/28′.

Moreover, it should be specified that it is possible to vary at will, in use, the pore size of the material to be screened by means of the bucket 1 by realizing the first basket 28 and the second basket 28′ as combination of two coaxial cylindrical bodies provided with perforated mantles so as to screen the excavated material.

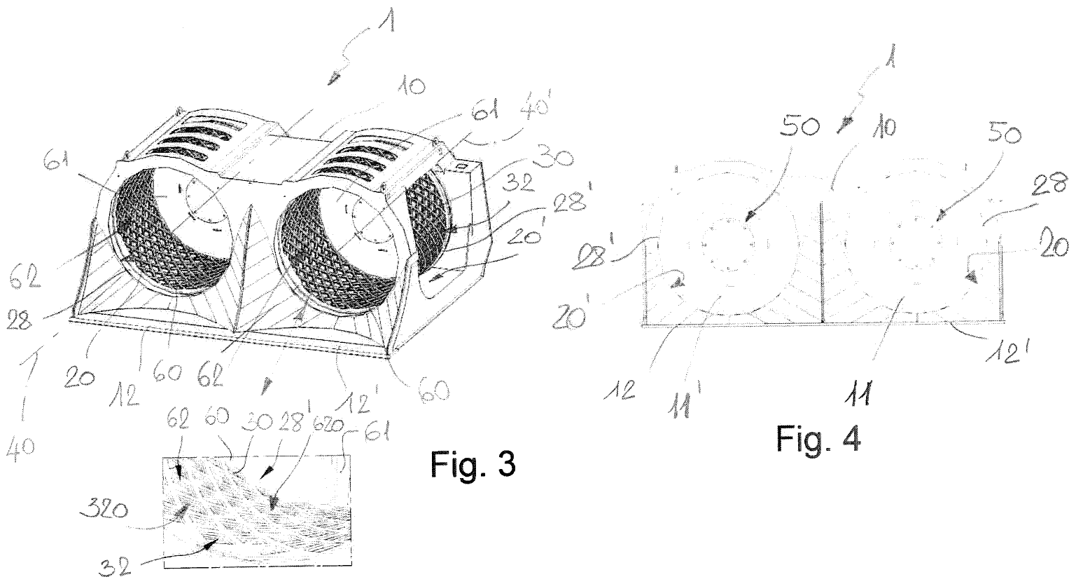

In particular, with reference to FIG. 3 and to the enlargement of e lower portion, each basket 28/28′ comprises a first outer cylindrical body 30 and a second inner cylindrical body 60, which are coaxially coupled in a longitudinally free and angularly fixed manner through a plurality of centring pins, known and therefore not shown. The first and the second cylindrical bodies 30 and 60 are made of metal sheet or of any other material that is functionally equivalent, and are coaxial with the central axis 40/40′ of the respective basket 28/28′.

With particular reference to FIG. 3, each cylindrical body 30 has a plurality of first rectangular holes 32, better shown in the enlargement of FIG. 3, for example moulded and arranged according to rectilinear directrixes wound on the cylindrical mantel of the first cylindrical body 30 similarly to the generatrixes of lined surfaces, according to a base angle of 45° with respect to the central axis 40/40′ of the respective basket 28/28′ and distributed at a given angular pitch.

Thanks to geometrically distribution of the holes 32, described above, the holes 32 are arranged longitudinally at a first given pitch P1; additionally, adjacent longitudinal rows of holes 32, that longitudinally overlap one another, are substantially displaced with respect to one another by a length that is slightly greater than a half diagonal of a hole 32.

With reference again to FIG. 3 and to the enlargement in FIG. 3, each second cylindrical body 60 has a plurality of second rectangular holes 62 arranged like the first holes 32 on the respective first cylindrical body 30, and therefore longitudinally at a second given pitch P2 in facing position with respect to the first holes 32. Therefore the first and the second holes 32/62 are respectively delimited by a first perimeter 320 and by a second perimeter 620, that are both rectangular in shape.

It shall be noted that, with particular reference to FIGS. 1 and 2, the second cylindrical body 60 has a second diameter that is slightly lower than a length of the first diameter of the first cylindrical body 32. The first holes 32 and the second holes 62 have substantially the same width, so that, in use, when they overlap each other, the filtering capability exerted by the combination of the first and the second cylindrical bodies 30/60 is equal to the filtering capability of the single first cylindrical body 30.

Each actuation device 50 comprises a fluid-dynamic actuator 52, for example, although without limitation, the type CPR-8 produced by Baltrotors, so as to be suitable to rotate at the same time the first cylindrical body 30 and the second cylindrical body 60, as well as to be suitable to move the second cylindrical body 60 longitudinally with respect to the first cylindrical body 30.

In view of the description above, each second cylindrical body 60 can be moved so as to be angularly fixed with respect to the respective first cylindrical body 30 around the corresponding central axis 40/40′. With reference to FIG. 2, each second cylindrical body 60 is axially closed (in rear position in FIGS. 1-4) by means of a disc 61 that is coaxial with the respective central axis 40/40′, closing at the back the second cylindrical body 60 and therefore the respective basket 28/28′. It is clearly apparent that each disc 61 has the function of closing, axially and at the back, the corresponding basket 28/28′ and of protecting the corresponding actuator 52 against the content of the basket 28/28′.

The operation of the basket 28/28′ and of the screening bucket 1 comprising them clearly appears from the description above and does not require further explanations. On the other hand, it should be specified that, in view of the description above, the material to be screened is loaded inside the baskets 28 and 28′, and the already screened material is discharged there from, only through the front opening of the basket 28/28′, without losing load at the back.

Moreover, it shall be also specified that providing a bucket 1 as described above allows to have a screening volume double with respect to the screening volume available with a single basket or, in a dual manner, to distribute the filtering capability of the bucket 1 as a whole horizontally instead of vertically. This allows to free the line of vision for the operator of the bucket 1 and allows therefore to use the bucket 1 in a safer manner than a bucket having only one basket of equal volume capability. Moreover, it should be specified that subdividing the volume of the excavated material in more baskets, arranged adjacent transversally to the movement direction of the vehicle also allows to limit the longitudinal dimensions of the mouth portions 60/60′, thus making the bucket 1 longitudinally shorter than a bucket of equal volume but provided with only one basket, and that can be therefore manoeuvred in an easier manner.

Lastly, it is clearly apparent that variants and modifications can be done to the screening bucket 1 described and illustrated herein without however departing from the protective scope of the invention.

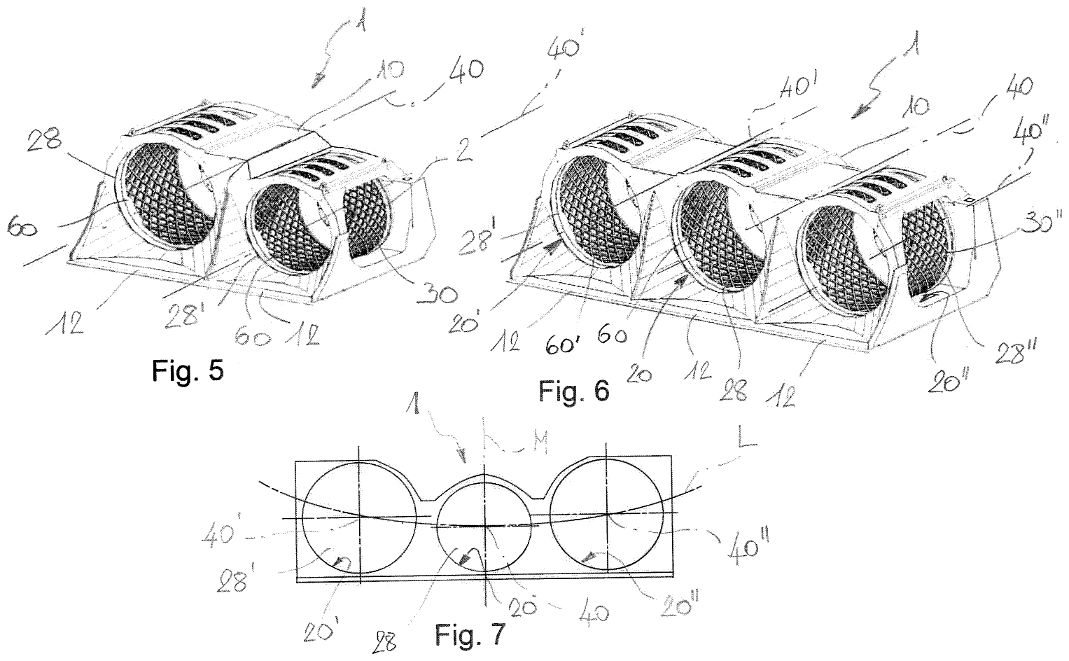

For example, in FIG. 5 the bucket 1 has been schematically represented to show a configuration wherein the first basket 28 and the second basket 28′ have different transversal dimensions according to specific needs of use.

It is easily understood that a bucket constructed as in the diagram of FIG. 5, and therefore provided with a pair of spaces for screening baskets of different transversal size can be installed on adequately designed machines. This construction choice therefore forces to realize the bearing structure of the bucket 1 so as to balance adequately the same bucket, as baskets of different capability, in use, load significantly different volumes, and therefore different masses. The concept of a bucket provided with baskets of different transversal width can be therefore declined so that the load constituted by the excavated material to be screened is substantially balanced for example by arranging the baskets uniformly with respect to a median plane M of the bucket.

In FIG. 6 a further embodiment of the bucket 1 has been illustrated, wherein the screening baskets are three, geometrically and functionally identical to one another. In particular, the second space 20′ and the third space 20″ are arranged at opposite sides from the first space and are suitable to house respectively a second screening basket 28′ and a third screening basket 28″ in a rotating manner around respective second pivot axis 40′ and third pivot axis 40″ that are parallel to the first pivot axis 40. The fact that the transversal dimensions of the second and the third baskets 30′ and 30″ are substantially identical allows to keep the bucket 1 always in operative conditions of balance from a dynamic point of view.

With reference to FIG. 7, a construction diagram is illustrated of a variant of the bucket 1, wherein the more external baskets 28′ and 28″ equidistant from the central basket 28 have increased diameters with respect to the central basket 28 so as to maximize the view in correspondence of the bucket centre. It should be noted that the shape and the distribution of the baskets 28, 28′ and 28″ make the bucket 1 statically balanced, so that it can be managed in an easier manner also from a dynamic point of view. Moreover, it should be noted that the first, the second and the third screening baskets 28, 28′, 28″ have respective pivot axes 40, 40′ and 40″ arranged along an imaginary curved line L lying on a plane transversal to the median plane M, wherein the line L has the concavity facing upwards.

Obviously, according to the specific needs, the arrangement and the sizes of the baskets can be such as to require an arrangement wherein the respective pivot axes are arranged according to a curve whose concavity faces downwards, or in any other manner. Moreover, if you want to minimize the height of the bucket 1, it should be useful to install on the same bucket screening baskets of very reduced outer diameter in a sufficient number to have a target screening capability. To do this it is obviously necessary to balance the operative needs and the construction difficulties, taking into account the whole transverse bulk of the bucket could be very large. In view of what described above it should be specified that a screening bucket realized like the bucket 1 represents a significant improvement with respect to the prior art, through which it is possible to overcome the prior art drawbacks, as it allows to free the view for the operator who can therefore manoeuvre the bucket in a freely and safe manner, directing it towards the material to be screened according to criteria that can be defined at will according to the specific and actual needs.

1. Screening bucket (1) provided with a box-type frame (10) having at least a first space (20) suitable to house a first screening basket (28) rotatable around a first pivot axis (40)(40′); said frame (10) having a mouth portion (12)(12′) and a longitudinal closing member (11)(11′) for each said space (20)(20′); each said first basket (28)(28′) being closed at the back;
characterized in that said frame (10) comprises at least one second space (20′) adjacent to said first space (20) and suitable to house a second screening basket (28′) rotatable around a second pivot axis (40′) parallel to said first pivot axis (40).

2. Bucket according to claim 1, characterized in that said first basket (28) and second basket (28′) are substantially identical.

3. Bucket according to claim 2, characterized in that said first basket (28) and second basket (28′) have different transverse dimensions.

4. Bucket according to claim 1, characterized in that said frame (10) comprises a third space (20″) adjacent to said first space (20) or to said second space (20′) and provided with a respective third screening basket (28″).

5. Bucket according to claim 4, characterized in that said first, second and third screening baskets (28)(28′)(28″) have different transverse dimensions.

6. Bucket according to claim 5, characterized in that said first, second and third screening baskets (28)(28′)(28″) have transverse dimensions increasing starting from a median plane (M) of said frame (10).

7. Bucket according to claim 6, characterized in that the respective pivot axes of said first, second and third screening baskets (28)(28′)(28″) are so arranged that an imaginary line (L) arranged transversally to said median plane (M) has the concavity facing upwards.

8. Bucket according to claim 7, characterized in that said first, second and third screening baskets (28)(28′)(28″) are cylindrical and functionally identical.
